(19) United States
(12) Patent Application Publication
(10) Pub. No.: US 2006/0244172 A1
(43) Pub. Date: Nov. 2, 2006

(54) Removable and replaceable inserts for pultrusion die

(76) Inventors: Edward E. Heald, Greenville, PA (US); Alfonso Branca, Milano (IT); Steven F. Schick, Sheboygan, WI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/527,856

(22) PCT Filed: Jun. 16, 2003
(86) PCT No.: PCT/US03/18938

§ 371 Date: Apr. 15, 2006

Related U.S. Application Data
(60) Provisional application No. 60/412,753, filed on Sep. 23, 2002.

(51) Int. Cl. B29C 70/52

(52) U.S. Cl. 264/136; 264/137; 425/113

(57) ABSTRACT

A modular pultrusion die containing removable and replaceable inserts (24, 26, 28) is described. The use of small removable and replaceable subunits in a pultrusion die allows for a variety of pultruded profiles to be formed more rapidly and substantially less costly than existing non-modular dies.

### BACKGROUND OF THE INVENTION

This invention relates to a pultrusion die with removable and replaceable inserts and a process for making pultruded parts using the die that incorporates these inserts.

Processes are known for producing a fiber-reinforced composite by drawing fibers into a pultrusion die, impregnating the fibers with resin, and simultaneously forming and curing the structure in a heated die. (See Encyclopedia of Polymer Science and Engineering, 2^{nd} Edition, Vol. 4, John Wiley & Sons, New York, pp. 1-28 (1986).)

Thermoplastic pultrusions are known in the art. For example, Hawley in U.S. Pat. No. 4,439,387, incorporated herein by reference, teaches the extrusion of molten thermoplastic resin material through a die which imbeds the fibers. In U.S. Pat. No. 4,559,262, Cogswell et al., incorporated herein by reference, discloses a fiber-reinforced composition that is obtained by drawing a plurality of fibers continuously through an impregnation bath, which is a static melt of a thermoplastic polymer of sufficiently low molecular weight (resulting in lower melt viscosity) to adequately wet the fibers. In, U.S. Pat. No. 5,891,560, Edwards et al., incorporated herein by reference, discloses the use of a repolymerizable and depolymerizable thermoplastic polyurethane resin to achieve complete impregnation of a high molecular weight thermoplastic resin into a fiber bundle by pultrusion. Similarly, in U.S. Pat. No. 5,911,932 Dyksterhouse discloses a pultrusion process wherein the fiber bundle is preheated sufficiently above the temperature of the resin bath to create localized reduction in viscosity, thereby allowing more efficient impregnation of a variety of thermoplastic resins into the fiber bundle.

Pultrusion profiles are determined by the configuration of the pultrusion die. Every unique die forms a unique profile. Consequently, if a change in profile is desired, the die either needs to be replaced and the glass rovings restrung or entirely separate pultruders are required. The process of replacing the die and restringing the glass is time consuming and complicated, thereby adding significantly to the cost of making pultruded composites. It would therefore be an advantage to have a single die capable of making multiple profiles quickly and efficiently.

### SUMMARY OF THE INVENTION

A modular pultrusion die comprising the following elements a-f communicating with each other in the order listed:
a) a fiber preheat station section containing inlets for the passage of fiber bundles;
b) a fiber infeed section
c) an resin infeed and impregnation section;
d) a reduction section;
e) a shaping and consolidation section that supports one or more removable and replaceable consolidation inserts; and
f) a cooling section that supports one or more removable and replaceable consolidation inserts.

In a second the aspect the present invention is a modular pultrusion die comprising the following elements a-f communicating with each other in the order listed:
a) a fiber preheat station section containing inlets for the passage of fiber bundles;
b) a fiber infeed section containing that supports one or more removable and replaceable fiber infeed inserts;
c) an resin infeed and impregnation section;
d) a reduction section;
e) a shaping and consolidation section; and
f) a cooling section.

In a third aspect, the present invention is a process of changing profiles in a modular pultrusion die comprising the steps of:
a) pultruding fiber through a pultrusion die containing any or all of the following removable and replaceable inserts: i) one or more consolidation inserts ii) one or more cooling inserts; and iii) one or more fiber infeed inserts;
b) stopping the pultruding of fiber;
c) removing any or all of the inserts and replacing the removed inserts with other inserts; and
d) restarting the pultrusion process.

The present invention addresses a need in the art of pultrusion by providing a fast and cost-effective way of changing pultruded profiles of fiber architecture.

### BRIEF DESCRIPTION OF THE DRAWINGS

FIG. 1 illustrates a cut-out section of a modular pultrusion die.

FIG. 2 illustrates a cut-out section of a mandrel attached to the impregnation section.

### DETAILED DESCRIPTION OF THE INVENTION

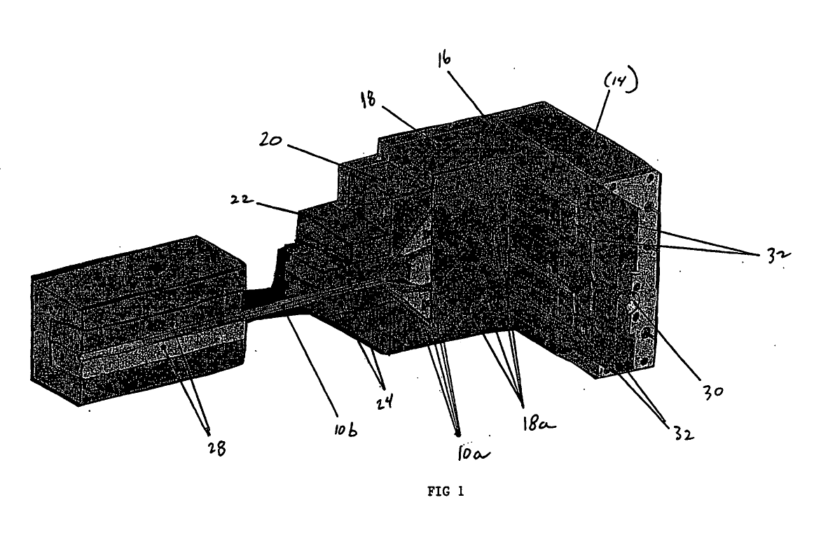

Referring now to FIG. 1, which depicts a cut-out section of the preferred modular pultrusion die of the present invention, fiber bundle and/or other form of fibrous reinforcement such as continous strand mat or woven mat (hereinafter fibers) is pulled through a fiber preheat station (14), which contains a heater such as an infrared ceramic heater or heated pins. Fibers may be composed of any of a number of different types of materials including glass, carbon, aramid fibers, ceramics, and various metals. The preheat station (14) is at least sufficiently hot to remove any water present in the fibers. Depending on the nature of the resin used, it may be desirable to preheat the fiber at or above the processing temperature of the resin, preferably not more than about 200 K higher, more preferably not more than about 100 K higher, and most preferably not more than 50 K higher than the processing temperature of the resin.

The fibers are then pulled through a fiber infeed section (16) that is optionally adapted to contain interchangeable inserts to control and position the fibers and provide a way to feed different kinds of architecture (for example, rovings, continuous strand mat and woven mat) into the pultruded profile. The fibers are then fed through a resin infeed and impregnation section (18). In the resin infeed portion, resin melt is fed through a heated resin inlet port (30) then split through a series of resin feed ports (32) through slots onto the fiber bundles. The melt is preferably prepared by extruding the resin through a heated extruder, which melts the resin by way of shear and heat. The impregnation portion contains one or more series of undulating channels (18a) or impregnation pins to promote efficient wet out and impregnation of the fibers with the resin melt. The resin infeed and impregnation section (18) is preferably maintained above the melting point of the resin.

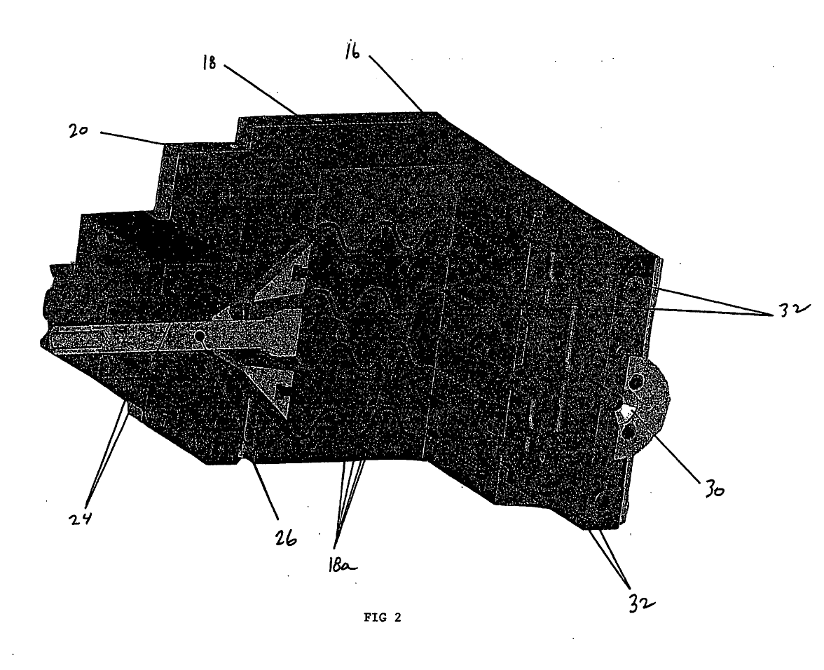

The impregnated fibers (10a) exit the resin infeed and impregnation section (18) then pass through a reduction section (20) to draw the multiple impregnated fibers (10a) close together, then through a consolidation die (22) that supports a removable and replaceable consolidation insert (24), which is preferably a split insert. The reduction section (20) optionally contains a removable and replaceable mandrel insert (26) supported by the resin infeed and impregnation section (18) as shown in FIG. 2. The consolidated fiber (10b) then passes through a cooling section (24) containing an interchangeable cooling insert (28), which can be split.

The fibers preferably constitute at least about 30 volume percent, more preferably at least about 40 volume percent, and most preferably at least about 50 volume percent of the total volume of the completed fiber-reinforced composite article, and the reinforcing fibers extend substantially through the length of the composite. The pultruded sections can be cut to any desired length, from millimeters to kilometers, and further shaped, formed, or joined using techniques well known in the art, including thermoforming, hot stamping, and welding.

Examples of resins suitable to make pultruded composites using the modular pultrusion die of the present invention include thermoplastics such as polystyrene, polyvinyl chloride, ethylene vinyl acetate, ethylene vinyl alcohol, polybutylene terephthalate, polyethylene terephthalate, acrylonitrile-styrene-acrylic, ABS (acrylonitrile-butadiene-styrene), polycarbonate, polypropylene, polyethylene, polyurethane, and aramid resins, and blends thereof. Polypropylene and depolymerizable and repolymerizable engineering thermoplastic polyurethanes (disclosed by Edwards et al. in U.S. Pat. No. 5,891,560, starting at column 4, lines 36 through column 6, line 28) are especially preferred resins.

The use of interchangeable inserts provides a way for a single die unit to produce multiple profiles, thereby reducing the cost of multiple dies. The specific use of the interchangeable split inserts provides a simple way to remove and replace consolidation and cooling inserts without removing glass from the die, thereby saving hours or even days of down time. Furthermore, the use of interchangeable inserts in the glass infeed allows great flexibility is designing the glass architecture.

Interchangeability of inserts is accomplished by fabricating a standard insert shape which the die is adapted to receive. This concept is not unlike changing the nozzle on a cake icing bag to make different shaped streams of icing.

The modular pultrusion die of the present invention eliminates the need for a new pultrusion unit any time a change in a shape of a pultruded profile is desired. All that is required is a single unit with removable and replaceable dies.

What is claimed is:

1. A modular pultrusion die comprising the following elements a-f communicating with each other in the order listed:
a) a fiber preheat station section containing inlets for the passage of fiber bundles;
b) a fiber infeed section;
c) a resin infeed and impregnation section;
d) a reduction section;
e) a shaping and consolidation section that supports one or more removable and replaceable consolidation inserts; and
f) a cooling section that supports one or more removable and replaceable consolidation inserts.

2. The modular pultrusion die of claim 1 which includes a removable and replaceable mandrel contained in the reduction section.

3. The modular pultrusion die of claim 1 wherein the removable and replaceable consolidation inserts are split inserts.

4. The modular pultrusion die of claim 3 wherein the removable and replaceable cooling inserts are split inserts.

5. The modular pultrusion die of claim 1 wherein the glass infeed section includes one or more removable and replaceable inserts.

6. A modular pultrusion die comprising the following elements a-f communicating with each other in the order listed:
a) a fiber preheat station section containing inlets for the passage of fiber bundles;
b) a fiber infeed section that supports one or more removable and replaceable fiber infeed inserts;
c) an resin infeed and impregnation section;
d) a reduction section;
e) a shaping and consolidation section; and
f) a cooling section.

7. A process of changing profiles in a modular pultrusion die comprising the steps of:
e) pultruding fiber through a pultrusion die containing any or all of the following removable and replaceable inserts: i) one or more consolidation inserts ii) one or more cooling inserts; and iii) one or more fiber infeed inserts;
f) stopping the pultruding of fiber,
g) removing any or all of the inserts and replacing the removed inserts with other inserts; and
h) restarting the pultrusion process.

8. The process of claim 7 wherein the consolidation and cooling inserts are removed and replaced with other consolidation and cooling inserts.

9. The process of claim 7 wherein the fiber infeed inserts are removed and replaced with other fiber infeed inserts.
